(19) United States
(12) Patent Application Publication
(10) Pub. No.: US 2018/0257275 A1
(43) Pub. Date: Sep. 13, 2018

(54) CARBON FIBER COMPOSITE

(71) Applicant: HEWLETT-PACKARD DEVELOPMENT COMPANY, L.P., HOUSTON, TX (US)

(72) Inventors: CHIENCHIH CHIU, TAIPEI CITY (TW); WEI-FENG YEN, TAIPEI CITY (TW); YONG YONG XU, TAIPEI CITY (TW); FENG GU, TAIPEI CITY (TW)

(21) Appl. No.: 15/759,338

(22) PCT Filed: Nov. 6, 2015
(86) PCT No.: PCT/CN2015/094028

§ 371 Date: Mar. 12, 2018

(51) Int. Cl. B29C 45/14; B32B 27/08; B32B 27/34; B32B 27/30; B32B 27/12; B29C 70/08; B29C 70/54

(52) U.S. Cl. CPC B29C 45/14065; B29L 2031/3481; B32B 27/34; B32B 27/308; B32B 27/12; B29C 70/086; B29C 45/14508; B29C 45/14786; B29C 70/541; B32B 2250/03; B32B 2250/40; B32B 2262/106; B32B 2307/732; B32B 2260/021; B32B 2260/046; B29C 2045/14532; B32B 27/08

(57) ABSTRACT

The present subject matter relates to carbon fiber composites. A method to form a polymer carbon fiber composite includes subjecting two sheets of carbon fibers to an insert molding mold, such that one sheet is secured at a cavity side of the insert molding mold and another sheet is secured at a core side of the insert molding mold. The method further includes insert molding a polymer between the two sheets of carbon fibers to form the polymer carbon fiber composite, wherein the polymer sets between the two sheets of carbon fibers to form a sandwich structure of the polymer carbon fiber composite, and wherein the polymer is in contact with the two sheets of carbon fibers.

### BACKGROUND

Designs for computing devices are ever changing. However, these designs are often limited by hardware components which enable device functionality. For example, hardware components affect certain aspects of design of a computing device, such as size, structure, and robustness. Portable computing devices are generally compact, and have robust designed chassis to withstand abrasions such as drops from elevated heights like from tables or from desks. Thus, chassis of computing devices, protecting various electronic parts, is manufactured with materials of high strength, such as carbon fiber composites.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates an example insert molded carbon fiber composite, according to an example implementation of the present subject matter;

FIG. 2 illustrates an example insert molding arrangement to form a polymer carbon fiber composite, according to an example implementation of the present subject matter;

FIG. 3 illustrates a perspective view of carbon fiber sheets utilized for insert molding, according to an example implementation of the present subject matter;

FIG. 4 illustrates an example method of forming an insert molded polymer carbon fiber composite, according to an example implementation of the present subject matter; and

FIG. 5 illustrates an example method of forming an insert molded polymer carbon fiber composite, according to an example implementation of the present subject matter.

### DETAILED DESCRIPTION

The present subject matter relates to carbon fiber composites. Chassis of computing devices are generally made of materials such as carbon fiber composites to protect the electronic components of the computing devices from accidental damage, and also safeguard the computing devices from wear and tear, arising out of their daily use. Further, carbon fiber composites are also used as shields for sensitive and costly components of the computing devices, such as displays and microprocessors.

Such carbon fiber composites are generally made using multiple sheets of carbon fibers. In such cases, 7 to 8 sheets of carbon fibers are stacked together and compressed at high temperatures to form the carbon fiber composite. Whilst the use of multiple sheets of carbon fibers provides support and strength to the carbon fiber composite, inclusion of multiple sheets of carbon fibers increases the cost of production of the carbon fiber composites. Further, the process of stacking, rolling and ‘forming’ of multiple sheets of carbon fibers at high temperatures is cumbersome and time consuming.

According to an example implementation of the present subject matter, carbon fiber composites are disclosed. Further, the example implementations of the present subject matter also disclose techniques of manufacture of such carbon fiber composites. The described carbon fiber composites may be produced at lower costs than general known carbon fiber composites formed by utilizing multiple sheets of carbon fibers. Furthermore, the described carbon fiber composites may also provide equivalent strength as provided by known carbon fiber composites.

In an example implementation of the present subject matter, two sheets of carbon fibers may be insert molded to form the cost effective carbon fiber composite. In the example implementation, the two sheets of carbon fibers may include an insert molded polymer layer in between such that the polymer layer is sandwiched between a top sheet of the carbon fiber and a bottom sheet of the carbon fiber. For the sake of explanation and clarity, the carbon fiber composite comprising polymer layer sandwiched in between may be referred to as a polymer carbon fiber composite, hereinafter.

In an example method of manufacture of the polymer carbon fiber composite, two sheets of carbon fibers may be subjected to an insert molding process such that a layer of polymer may be insert molded between the two sheets of carbon fibers. In operation, one sheet of carbon fiber may be secured at a cavity side of the insert molding mold, and the other sheet of carbon fiber may be secured at a core side of the insert molding mold. It would be noted that the insert molding process may include a separate core side and a separate cavity side such that a material to be insert molded may be inserted in between the core side and the cavity side.

In an example implementation of the present subject matter, the two sheets of carbon fibers may be secured by support pins. The support pins may secure one sheet of carbon fiber with the cavity side of the insert molding mold, and the other sheet with the core side of the insert molding mold. In an example, the support pins may secure the two sheets based on vacuum suction, such that the edges of the sheet are held stable during the insertion of molten polymer.

It would be noted that the polymer carbon fiber composite may be a 3-dimensional structure that may be molded in a predefined shape during the insert molding process, depending upon the application of the polymer carbon fiber composite. It would further be noted that since the polymer carbon fiber composite includes carbon fibers as the outer layers, the carbon fibers may provide strength to the entire polymer carbon fiber composite, and the polymer carbon fiber composite may act as a strong and robust material for shielding computing devices, and its components, against abrasions and accidental damages. Further, since the polymer carbon fiber composite utilizes merely two sheets of carbon fibers, the cost of production of the polymer carbon fiber composite may also be lower than known carbon fiber composites.

The above described techniques are further described with reference to description of following figures. It should be noted that the description and the figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

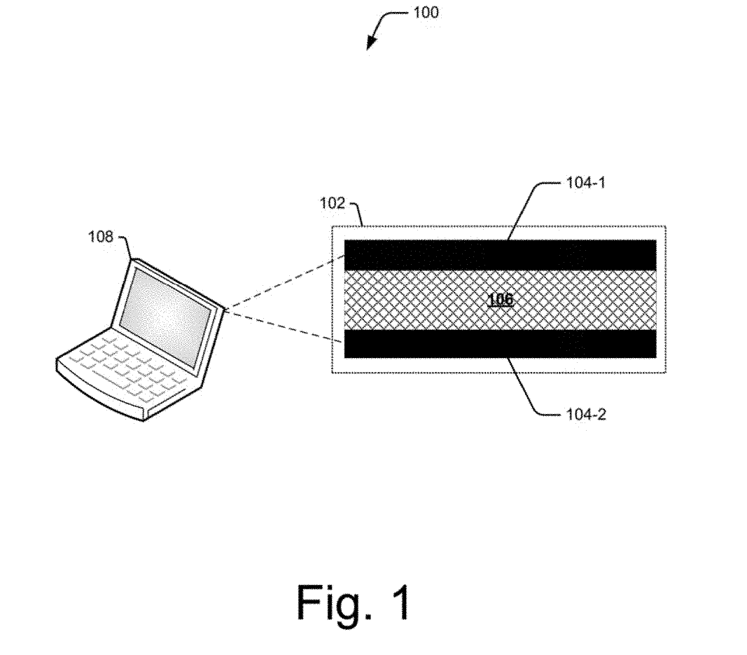

FIG. 1 illustrates an example insert molded polymer carbon fiber composite 102, according to an example implementation of the present subject matter. The polymer carbon fiber composite 102 may be prepared through the process of insert molding. In operation, to form the polymer carbon fiber composite, two sheets of carbon fibers, a first sheet of carbon fiber 104-1 and a second sheet of carbon fiber 104-2 may be utilized, where a polymer layer 106 may be insert molded between the two sheets of carbon fibers. For the ease of explanation, the two sheets of carbon fibers have been collectively referred to as carbon fibers 104.

The two sheets of carbon fibers 104 may be formed from any carbon fiber raw material, such as gaseous hydrocarbons, petroleum, coal, biomass, polymers, and prepolymers. Further, the polymers and the prepolymers may include any one of, but not limited to, resins, polyamides, and Polyacrylonitriles. Furthermore, the density of the two sheets of carbon fibers 104 may be between 1.2 Kilogram per meter cube (Kg/m³) and 2.0 Kg/m³, depending upon the raw material utilized for the purpose of manufacture of the carbon fiber.

Further, the polymer layer 106, insert molded between the two sheets of carbon fibers 104, may be made of any type including, but not limited to, a thermosetting polymer, a thermoplastic polymer, and an elastomer. The polymer may itself be of any material including, but not limited to, epoxy, polyester, vinyl ester, and nylon. Furthermore, the density of the polymer may be between 0.6 Kg/m³ and 1.2 Kg/m³. In an example implementation of the present subject matter, the density of the polymer may be less than the density of the carbon fibers.

In an example implementation of the present subject matter, the two sheets of carbon fibers 104 may be of about 0.1 millimeter (mm) to about 1.3 mm in thickness. Further, the polymer layer 106 may be of about 0.4 mm to 1.0 mm in thickness.

The polymer carbon fiber composite 102 may have high strength-to-weight ratio, and therefore, may be utilized to form chassis of computing devices, such as, but is not limited to, a server, a workstation, a desktop computer, a laptop, a smart phone, a personal digital assistant (PDAs), a network storage device, a tablet, and the like. Further, the polymer carbon fiber composite 102 may also be utilized to cover and protect components of the computing devices, such as random access memory (RAM), processing resources like central processing unit (CPU), and/or other types of nonvolatile memory. Additional components which may be covered and protected by the polymer carbon fiber composite 102 may include, but not limited to, disk drives, network ports, keyboards, touchpads, and displays. In an example implementation of the present subject matter, the first sheet of carbon fiber 104-1 may form an outer shield of the polymer carbon fiber composite 102, and the second sheet of carbon fiber 104-2 may form an inner shield of the polymer carbon fiber composite 102.

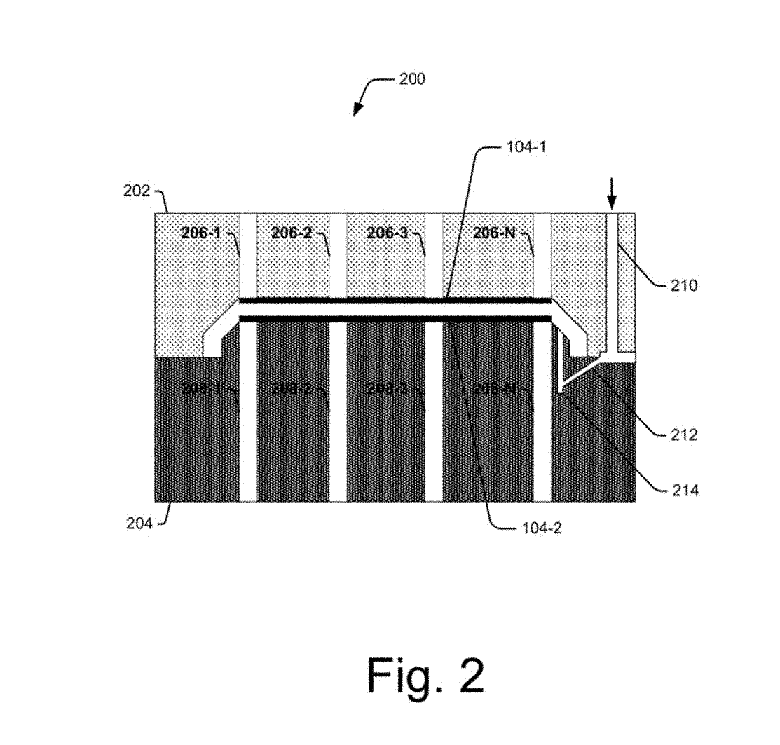

FIG. 2 illustrates an example insert molding arrangement to form a polymer carbon fiber composite, according to an example implementation of the present subject matter.

In an example, the insert molding arrangement may include an insert molding mold 200 to form the polymer carbon fiber composite 102. In an example implementation of the present subject matter, the first sheet of carbon fiber 104-1 may be secured at a cavity side 202 of the insert molding mold 200. Similarly, the second sheet of carbon fiber 104-2 may be secured at a core side 204 of the insert molding mold 200. It would be noted that the insert molding mold 200 may include the two sides, the cavity side 202 and the core side 204 for the purpose of securing sheets and insert molding a polymer, in between the carbon fibers 104.

Moreover, the carbon fibers 104 may be held together at a predetermined distance from each other, such that the polymer layer 106 may be insert molded between the carbon fibers 104. Further, the two sheets of carbon fibers 104 may be held such that the two sheets of carbon fibers 104 are substantially parallel to each other. In an example implementation of the present subject matter, the predetermined distance between the two sheets of carbon fibers 104 may be such that the thickness of the polymer layer 106, to be insert molded in between the two sheets of carbon fibers 104, is about the predetermined distance. As explained earlier, in an example implementation of the present subject matter, the predetermined thickness may be of about 0.4 mm to 1.0 mm.

In operation, the cavity side 202 and the core side 204 of the insert molding mold 200 may include support pins to secure the sheets of carbon fibers 104 within the mold 200. The cavity side 202 of the insert molding mold 200 may include multiple support pins 206-1, 206-2, 206-3, . . . , 206-N to hold the first sheet of carbon fiber 104-1. Similarly, the core side 204 of the insert molding mold 200 may include multiple support pins 208-1, 208-2, 208-3, . . . 208-N to hold the second sheet of carbon fiber 104-2. For the ease of explanation, the support pins 206-1, 206-2, 206-3, . . . , 206-N have been commonly referred to as cavity support pins 206, and the support pins 208-1, 208-2, 208-3, . . . , 208-N have been collectively referred to as core support pins 208.

The cavity support pins 206 and the core support pins 208, in an example implementation, may include suction inserts which may hold the sheets of carbon fibers. In one example, the suction inserts may hold the sheets of carbon fibers through vacuum suction. It would be noted that the support pins may be implemented such that the sheets of carbon fibers are held stable during the process of insert molding.

During the process of insert molding, molten polymer, in the form of resin, may be inserted through a runner 210. The runner 210 may be an opening within the insert molding mold 200 to transport the polymer between the two sheets of carbon fibers 104. The runner 210 may further be coupled with at least one sub-gate 212 and at least one rib 214 to transport the polymer. In an example implementation of the present subject matter, the sub-gate 212 and the ribs 214 may be placed such that the polymer may be evenly distributed between the two sheets of carbon fibers 104.

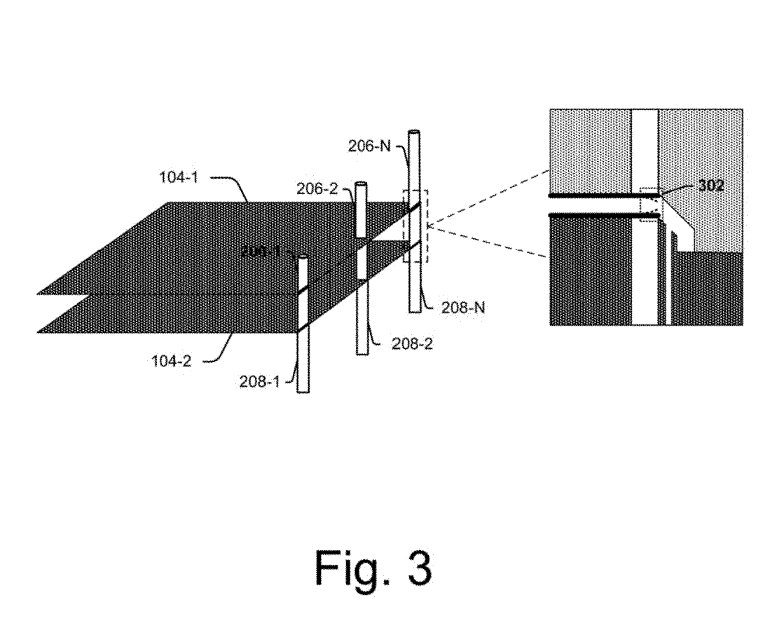

FIG. 3 illustrates a perspective view of carbon fiber sheets, during the process of insert molding, according to an example implementation of the present subject matter. Whilst the polymer flows through the runner 210 and the sub-gate 212, due to the flow of the polymer, the sheets of carbon fibers 104 may deform at the entry region 302, and may bend inwards. The deformation may cause accumulation of polymer at the outer surfaces of the polymer carbon fiber composite 102, and may also reduce the even penetration of the polymer between the sheets of carbon fibers 104. To avoid such deformation of the two sheets of carbon fibers 104 at the entry region 302, amongst other things, the cavity support pins 206 and the core support pins 208 may be placed near the edge of the respective sheets of carbon fibers 104. For instance, the cavity support pin 206-N may be placed near the edge of the sheet of carbon fiber 104-1 to hold the sheet of carbon fiber 104-1 stable during the injection of the polymer. Similarly, the core support pin 208-N may be placed near the edge of the sheet of carbon fiber 104-2 to hold the sheet of carbon fiber 104-1 stable during the injection of the polymer.

It would be noted that the sub-gate 212, for the insertion of the polymer, may be placed on either side of the sheets of carbon fibers 104. That is, the runner 210 and sub-gate 212 has been shown to be included to the right of the cavity support pin 206-N and the core support pin 208-N, however, in an example implementation of the present subject matter, similar runner and sub-gate may also be included to the left of the cavity support pin 206-1 and the core support pin 208-1. Accordingly, the cavity support pin 206-1 and the core support pin 208-1 may be placed along the right edge of the sheets of carbon fibers 104 to hold the sheets of carbon fibers 104 stable.

The placement of the cavity support pin 206-N near the edge of the sheet of carbon fiber 104-1, and the core support pin 208-N near the edge of the sheet of carbon fiber 104-2, may hold the two sheet of carbon fibers 104 stable during the process of polymer injection. The edges of the two carbon fibers 104 may not deform at the entry region 302 and allow formation of the polymer carbon fiber composite 102.

It would be noted that whilst examples of placement of the cavity support pins 206 and the core support pins 208 may be explained with respect to associated figures, different arrangements of the support pins may be undertaken, depending upon the method of insert molding the polymer carbon fiber composite 102.

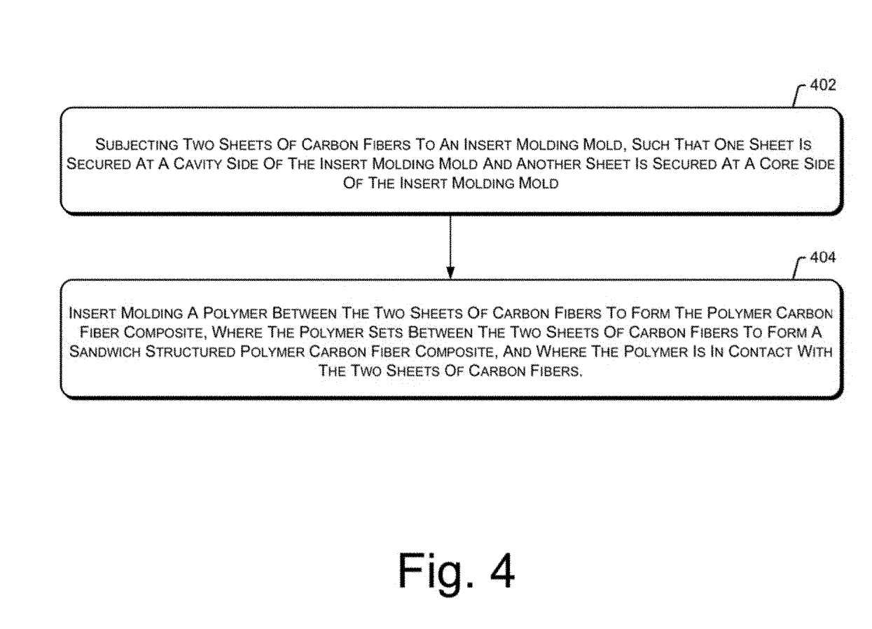

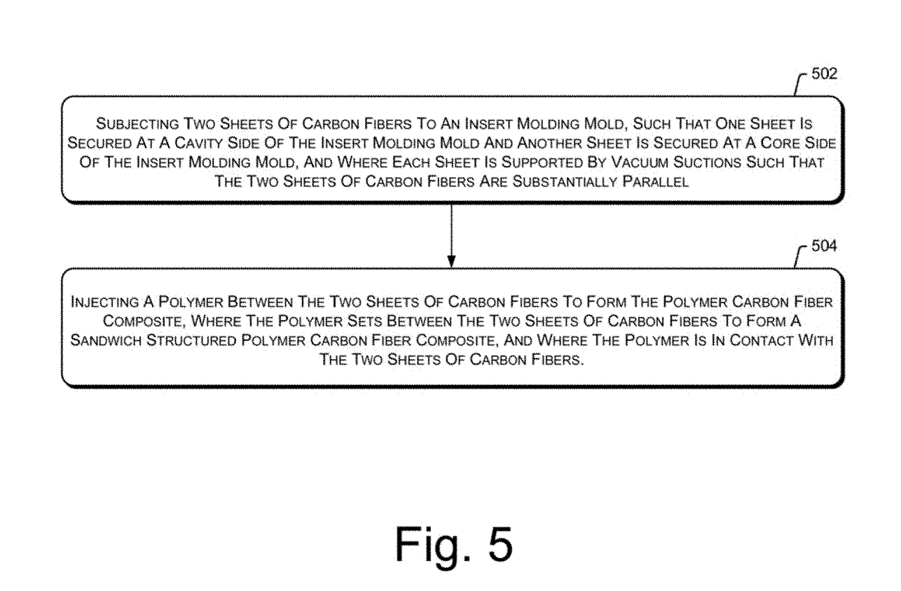

FIG. 4 and FIG. 5 illustrate methods 400 and 500, respectively, of forming an insert molded polymer carbon fiber composite, according to an example implementation of the present subject matter. The order in which the methods 400 and 500 are described are not intended to be construed as a limitation, and any number of the described method blocks may be combined in any order to implement the methods 400 and 500, or any other alternative methods. Furthermore, the methods 400 and 500 may be implemented by processor(s) or computing device(s) through any suitable hardware, non-transitory machine readable instructions, or combination thereof.

Referring to FIG. 4, at block 402, two sheets of carbon fibers may be subjected to an insert molding mold, such that one sheet is secured at a cavity side of the insert molding mold and another sheet is secured at a core side of the insert molding mold. In an example implementation of the present subject matter, the sheet of carbon fiber 104-1 may be secured at the cavity side of the insert molding mold 200, and the sheet of carbon fiber 104-2 may be secured at the core side of the insert molding mold 200.

In an example, the two sheets of carbon fibers may be secured by at least one support pin on either of the cavity side and the core side of the insert molding mold 200. The support pins may include suction inserts to hold the sheets of the carbon fibers. The suction inserts may hold the sheets of carbon fibers based on vacuum suction to keep the sheets of carbon fibers stable during the process of insert molding.

At block 404, a polymer may be insert molded between the two sheets of carbon fibers to form the polymer carbon fiber composite. The polymer may set between the two sheets of carbon fibers to form a sandwich structured polymer carbon fiber composite. Further, the polymer may be in contact with the two sheets of carbon fibers.

Referring to FIG. 5, at block 502, two sheets of carbon fibers may be subjected to an insert molding mold, such that one sheet is secured at a cavity side of the insert molding mold and another sheet is secured at a core side of the insert molding mold. Further, each sheet may be supported by vacuum suctions such that the two sheets of carbon fibers are held substantially parallel.

At block 504, a polymer may be injected between the two sheets of carbon fibers to form the polymer carbon fiber composite. The polymer may set between the two sheets of carbon fibers to form a sandwich structured polymer carbon fiber composite, such that the polymer is in contact with the two sheets of carbon fibers.

In an example implementation of the present subject matter, the vacuum suctions may secure the two sheets of carbon fibers such that they are held stable during the injection of the polymer. Further, the vacuum suction may prevent any deformation of the edges of the two sheets of the carbon fibers at the entry region of the polymer resin.

Although process of formation of the polymer carbon fiber composite have been described in language specific to structural features and/or processes, it is to be understood that the present subject matter is not necessarily limited to the specific features or processes described. Rather, the specific features and processes are disclosed and explained in the context of a few implementations for formation of the polymer carbon fiber composite.

What is claimed is:

1. A method to form a polymer carbon fiber composite, the method comprising:
subjecting two sheets of carbon fibers to an insert molding mold, such that one sheet is secured at a cavity side of the insert molding mold and another sheet is secured at a core side of the insert molding mold; and
insert molding a polymer between the two sheets of carbon fibers to form the polymer carbon fiber composite, wherein the polymer sets between the two sheets of carbon fibers to form a sandwich structure of the polymer carbon fiber composite, and wherein the polymer is in contact with the two sheets of carbon fibers.

2. The method as claimed in claim 1, wherein the method further comprises securing the two sheets of carbon fibers in the insert molding mold by support pins such that the sheets of carbon fibers are substantially parallel to each other, and wherein the sheets of carbon fibers are separated by a predetermined distance.

3. The method as claimed in claim 2, wherein the support pins support the two sheets of carbon fibers by vacuum suction such that the edges of the two sheets of carbon fibers are held stable during the insert molding of the polymer.

4. The method as claimed in claim 1, wherein the method further comprises supporting the two sheets of carbon fibers in the insert molding mold by suction inserts such that the sheets of carbon fibers are substantially parallel to each other.

5. The method as claimed in claim 1, wherein the insert molding the polymer between the two sheets of the carbon fibers is through a sub-gate of the insert molding mold.

6. The method as claimed in claim 5, wherein the sub-gate is coupled with at least one rib to allow insert molding of the polymer between the two sheets of carbon fibers.

7. The method as claimed in claim 1, wherein the density of carbon fibers is between 1.2 Kg/m³ and 2.0 Kg/m³.

8. The method as claimed in claim 1, wherein the density of the polymer is between 0.6 Kg/m³ and 1.2 Kg/m³, and is lower than the density of the sheet of carbon fibers.

9. The method as claimed in claim 1, wherein the polymer is one of a thermosetting polymer, thermoplastic polymer, and elastomer.

10. A polymer carbon fiber composite for computing devices, wherein the polymer carbon fiber composite comprises:
a first sheet of carbon fiber disposed as top layer of the polymer carbon fiber composite;
a second sheet of carbon fiber disposed as bottom layer of the polymer carbon fiber composite; and
an insert molded polymer layer disposed between the first sheet of carbon fiber and the second sheet of carbon fiber such that the polymer layer is sandwiched between the first and the second sheet of carbon fibers, wherein the polymer layer is in contact with the first sheet of carbon fiber and the second sheet of carbon fiber.

11. The polymer carbon fiber composite as claimed in claim 10, wherein the first sheet of carbon fiber forms an outer shield of the polymer carbon fiber composite for protection of parts of the computing device.

12. The polymer carbon fiber composite as claimed in claim 10, wherein during the insert molding the first sheet and the second sheet of carbon fibers are supported by vacuum suction such that the edges of the two sheets of carbon fibers are held stable.

13. The polymer carbon fiber composite as claimed in claim 10, wherein thickness of each of the first sheet of carbon fiber and the second sheet of carbon fiber is about 0.1 millimeter (mm) to 1.3 mm.

14. The polymer carbon fiber composite as claimed in claim 10, wherein the first sheet of carbon fiber and the second sheet of carbon fiber are separated by a predetermined distance, and wherein thickness of the polymer layer is about the predetermined distance.

15. The polymer carbon fiber composite as claimed in claim 14, wherein the predetermined distance is between 0.4 mm to 1.0 mm.

16. A method to form a polymer carbon fiber composite by insert molding, the method comprising:
subjecting two sheets of carbon fibers to an insert molding mold, such that one sheet is secured at a cavity side of the insert molding mold and another sheet is secured at a core side of the insert molding mold, wherein each sheet is supported by vacuum suctions such that the two sheets of carbon fibers are substantially parallel; and
injecting a polymer between the two sheets of carbon fibers to form the polymer carbon fiber composite, wherein the polymer sets between the two sheets of carbon fibers to form a sandwich structure of the polymer carbon fiber composite, and wherein the polymer is in contact with the two sheets of carbon fibers.

17. The method as claimed in claim 16, wherein the vacuum suction supports edges of the two carbon fiber sheets such that edges of the two carbon fiber sheets are held stable during the injection of the polymer.
